(19) United States
(12) Patent Application Publication
(10) Pub. No.: US 2024/0034085 A1
(43) Pub. Date: Feb. 1, 2024

(54) Method and device for printing onto containers made of glass

(71) Applicant: KRONES AG, Neutraubling (DE)

(72) Inventors: Georg GERTLOWSKI, Schierling (DE); Zsolt ROZSNYAI, Straubing (DE); Christian PORTELE, Thalmassing (DE); Sven KERPE, Linkenheim- Hochstetten (DE); Robert WEIKL, Regensburg (DE)

(21) Appl. No.: 18/256,415

(22) PCT Filed: Oct. 27, 2021
(86) PCT No.: PCT/EP2021/079804

§ 371 Date: Jun. 7, 2023

(30) Foreign Application Priority Data
Dec. 11, 2020 (DE) 10 2020 133 108.8

(51) Int. Cl. B41M 5/00; C03C 17/00; C03C 23/00; B41J 3/407; B65D 23/08; C03B 9/13

(52) U.S. Cl. CPC B41M 5/0088; C03C 17/005; C03C 23/007; B41J 3/40733; B65D 23/0814; C03C 23/006; B41M 5/007; C03C 2218/31; C03C 2218/119; C03B 9/13

(57) ABSTRACT

A method and a device for printing onto containers, in particular bottles, made of glass are described. Containers that have been heated and coated by hot end coating are received from a transport section and transferred to a printing machine. The containers are cooled to a printing temperature in the region of the transport section and/or of the printing machine are provided with a printed image in the printing maching by direct printing. This allows for high-quality direct printing with sufficient resistance to mechanical stresses without cold end coating of the containers prior to the direct printing and/or without the resulting effort of improving the adhesive action of the print or of removing the cold end coating in the print region at least in part.

### TECHNICAL FIELD

The invention relates to a method and a device for printing onto containers made of glass, in particular bottles, as to a corresponding container.

### BACKGROUND AND SUMMARY

Glass bottles are known to be used for bottling beverages and are exposed to many influences and stresses in production methods as well as during transport and use, which can negatively affect the quality and condition of the glass bottles. Examples of this are mechanical stresses resulting in abrasion, scratches, or the like, as well as chemical and thermal influences. In order to keep wear and tear of glasses to a minimum, it is therefore customary to apply protective layers directly after the bottle has been manufactured.

For this purpose, a hot end finish is performed at temperatures of around 500 to 700° C., for example, by applying tin oxide. This serves to close micro-cracks and increases abrasion resistance. After the glass bottles have cooled down, cold end coating is typically performed at around 150° C., for example, by applying polyethylene wax, which further improves scratch and abrasion resistance.

The problem, however, is that this degrades the adhesion of printed images that are printed directly onto the glass bottles, for example, by screen printing or inkjet printing.

Complex pretreatment is therefore often necessary prior to direct printing in order to obtain the required adhesion and resilience of the printed image, i.e. the color layers applied, on the coating layer resulting after cold end coating. For example, the bottles are flamed for this purpose and a precursor is added to the flame. As a result, a SiOx layer is applied to the flamed surface. Immediately afterwards, a bonding agent, a so-called silane coupling agent, is sprayed on. It then reacts in a suitable manner with the printing color. This results in the following layer structure: glass, SiOx layer, bonding agent, printing color.

Alternatively, methods are known with which coating layers can be removed again in part or entirely in order to print onto the wall regions thus treated, if appropriate using bonding agents. This as well is technically very complex, cost-intensive, and difficult to control in terms of process technology.

There is therefore a need for improved methods and devices for printing onto glass bottles or similar containers while producing sufficiently resistant wall surfaces and prints.

The object posed is satisfied by a method according to claim 1, a container according to claim 11, and a device according to claim 12. Preferred embodiments are specified in the dependent claims.

The method is used for printing onto containers made of glass, in particular bottles, where containers that have been coated and heated by hot end coating are received from a transport section and transferred to a printing machine, where the containers are cooled down to a printing temperature in the region of the transport section and/or of the printing machine and where the containers are provided with a printed image in the printing machine by direct printing.

As a result, cold end coating of the containers, which is particularly critical for direct printing in terms of adhesion/resilience, can be dispensed with.

The containers are made of silicate glass and can be provided by a glass machine for the production of hollow glass bodies in a manner that is known in principle.

The hot end coating preferably produces a hot end coating layer in the outfeed region of the glass machine, for example, in the form of at least one metal oxide based on tin, titanium, or a similar metal. The surfaces produced in this manner are relatively rough and stable.

The printing temperature is preferably 10 to 50° C., in particular 20 to 40° C.

The containers are preferably transported separated and at a distance from one another from an infeed region of the transport section to the direct printing. The transport section comprises, for example, a conveyor belt and a suitable speed control device to create distances/gaps between consecutive containers. This prevents the containers from scratching during transport.

Separation is to mean the containers do not contact during transport and handling.

The containers are preferably guided and/or held on the transport section, leaving a lateral wall region free that is provided for the printed image. For example, a clamp system with holding devices for the neck and base/heel region of the containers is suitable for this purpose. A transport section based on a long stator system with actively driven carriages (movers) is also conceivable in this context. Contact between the respective gripper and the container can then be limited to wall regions that are not to be printed on, in order to enable transport that is as gentle as possible without scratching the print areas of the container.

The containers preferably have at least one rubbing edge/friction edge formed from glass which keeps the lateral wall regions of the containers for receiving the printed image at a distance from one another when the containers contact each other, or a rubbing edge/friction edge corresponding functionally in this regard is applied by direct printing. This enables transportation of the containers in which the wall regions of the containers provided for or equipped with the printed image do not contact one another and are additionally protected against contacting guide elements such as railings or the like. In this way, an optically flawless printed image can be created and maintained during transport.

The containers are preferably cooled down to the printing temperature in a cooling tunnel. As a result, the containers can be printed onto, for example, at room temperature and optionally under mechanically air-conditioned conditions, which simplifies their handling.

In addition, the containers can also be dried in the cooling tunnel.

Direct printing preferably comprises the application of a primer layer, in particular in the form of a bonding agent, onto a coating layer produced by the hot end coating.

The printed image is preferably produced by way of inkjet printing, in particular by applying UV-curing inks.

Inkjet printing can be electronically controlled in a flexible manner to produce different printed images and enables high-quality printing. UV-curing inks can be affixed quickly, selectively, and economically using UV pinning lamps, for example, based on LEDs. For example, white is printed on first, followed by chromatic colors.

With pinning lamps, the so-called spreading of the printing colors/inks can also be controlled and the print quality can be optimized thereby. For example, UV lamps (e.g. doped with Hg, Fe, Ga) are used to completely cure the inks. Curing by way of LED UV lamps is particularly advantageous. They can be configured for pinning as well as for complete curing. For this purpose, for example, different light sources can be combined in one UV lamp, in particular with different radiation power and/or different radiation spectra. In principle, any actinically effective radiation is conceivable for the pinning/curing.

In principle, however, printing colors/inks based on water or other solvent that evaporates during curing are also conceivable. In this case, a primer (base coat) can possibly be applied beforehand in order to avoid spreading too quickly on the basically non-absorbent wall material. The primer thereby ensures good print quality due to the appropriate spreading of the printing colors and can also control the brilliance of the print.

Direct printing at a printing temperature that is higher than room temperature (20 to 25° C.) can be advantageous, in particular with solvent-based printing colors/inks, since the solvent (water) then evaporates more quickly. This means that, in the case of physically curing printing colors/inks (based on the evaporation of solvents, in particular water), the containers can be moved into the printing machine while still warm and printed onto there so that the printing colors/inks dry/cure faster than at room temperature.

For this purpose, the cooling tunnel can be appropriately controlled to adjust the printing temperature.

The printing colors/inks are preferably of such nature that, in addition to good spreading of the ink on the surface, sufficient adhesion properties are also obtained. This can be achieved, for example, by using adhesion-improving raw materials in the ink. The liquids to be filled into the containers, in particular beverages, may have to be pasteurized to preserve them. The containers are then exposed to high temperatures and humidity. The printing colors/inks are preferably of such nature that they cannot bleed under these conditions and cannot become detached from the container.

If the direct adhesion of the printing colors/inks on the hot end coating layer is insufficient, then the printing method can be supplemented by applying therebetween a primer with a bonding agent/coupling agent (e.g. silane, zirconate, titanate bonding agent). For this purpose, the hot end coating and the primer can be matched to each other in order to optimize the overall adhesion of the printed image.

The printing colors/inks can have a mechanical protective function, for example, by containing waxes or similar additives that make the inks harder or more resilient to mechanical influences overall. Should additional protection be desired, then a transparent protective varnish can be applied for this purpose by inkjet printing. The protective varnish can be applied over the entire surface or also over part. It can also be used to create a rubbing edge/friction edge having an appropriate layer thickness.

Another way to protect the containers is to apply a cold end coating after direct printing. A respective coating layer can be applied over the entire area or in part as long as the requirements for the printed image are met.

In principle, direct printing in the form of screen printing would also be conceivable. For this purpose, annealable printing colors or UV-curing printing colors could be used.

Direct printing preferably comprises the application of a transparent protective layer onto the printed image applied.

In a favorable embodiment, final curing of physically, i.e. by evaporation of a solvent, in particular water, curing printing colors in the printed image takes place in a drying tunnel, i.e. only after direct printing has been completed.

The containers transported separated are preferably combined by machine downstream of the direct printing into packs and/or by palletizing for multiple transport.

The method is, for example, part of a method for producing containers, in particular bottles, made of glass for bottling beverages, where the production method involves melt-forming the containers, their hot end coating immediately downstream and the immediately downstream execution of the method according to at least one of the embodiments described above and/or below.

The object is also satisfied by a container, in particular a bottle, made of glass, comprising: a container body made of silicate glass, a hot end coating layer formed thereon and a printed image applied thereonto in direct printing directly or by way of an adhesion layer, in particular according to at least one embodiment described above and/or below of the method according to the invention.

The printed image is to be understood to be a label printed directly onto the container.

The device is used for direct printing onto containers, in particular bottles, made of glass, following their hot end coating and comprises: a printing machine for direct printing onto the containers, in particular by way of an ink jet; at least one transport section for, in particular, separated transport of the hot-end-coated containers from an outfeed region of a hot end coating unit to the printing machine; and a cooling tunnel arranged in the region of the transport section for cooling down the containers heated as a result of the hot end coating, to a printing temperature for direct printing.

The device preferably also comprises a drying tunnel arranged downstream of the printing machine for final curing by evaporating a solvent of curing printing colors/inks and/or a packing machine for combining/grouping the containers for multiple transport in packs and/or on pallets.

The device furthermore preferably comprises a pretreatment unit arranged in the region of the transport section and/or of the printing machine for preparing a coating layer produced on the containers with hot end coating by way of plasma treatment and/or flame treatment and/or for spraying on an adhesion layer for the respective subsequent direct printing.

The pretreatment unit is then set up in particular to apply a SiOx adhesion layer (SiOx coupling agent) by way of an admixed precursor.

In addition, the pretreatment unit could be configured to spray on a primer/bonding agent in order to build up a covalent or intermolecular interaction with the printing color.

The transport section preferably comprises holders/grippers that are movable in the transport direction for a neck finish portion and/or base portion of the containers.

The device is preferably part of a device for the production of containers, in particular bottles, made of glass, and upstream thereof comprises a glass machine for melt-forming the containers and a downstream hot end coating unit for producing a hot end coating layer on the containers.

However, prefabricated containers can also be supplied to the device for printing onto the former.

### BRIEF DESCRIPTION OF THE FIGURES

Preferred embodiments of the invention shall be illustrated by way of drawings, where:

FIG. 1 shows a schematic top view onto an embodiment of the device;

FIG. 2 shows a schematic side view of a container on the transport section;

FIG. 3 shows a schematic illustration of the method with direct printing based on UV-curing printing colors; and

FIG. 4 shows a schematic illustration of the method with direct printing based on solvent-based printing colors.

### DETAILED DESCRIPTION

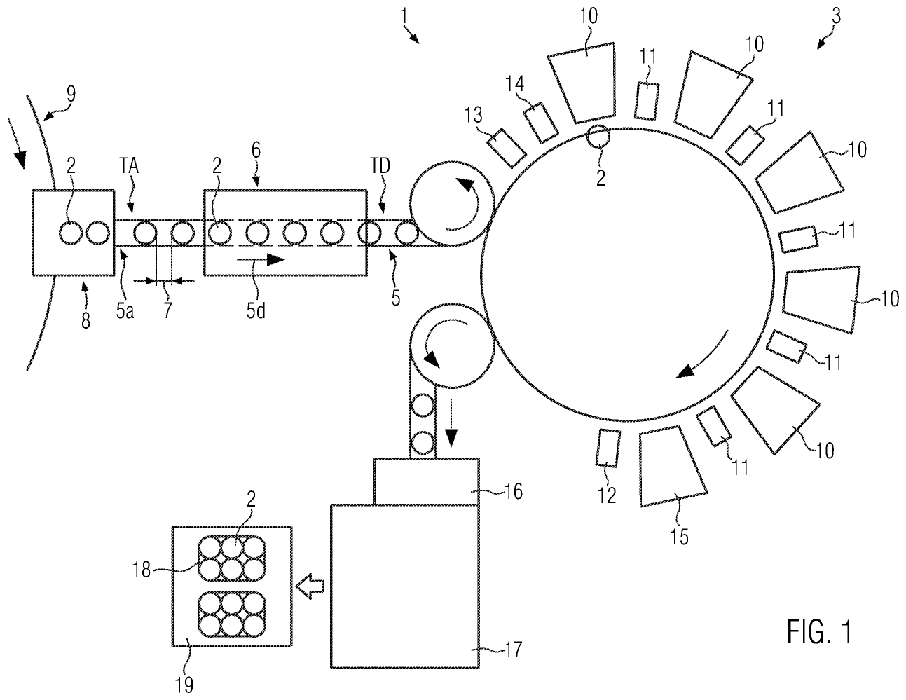

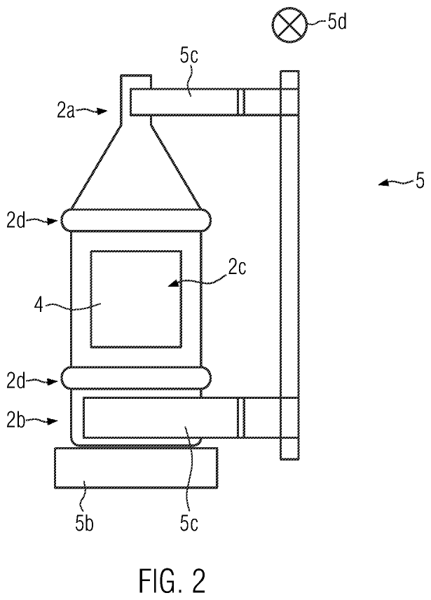

As can be seen in FIG. 1, device 1 for direct printing onto containers 2 made of a silicate glass following their hot end coating comprises a printing machine 3 for direct printing of a printed image 4 (shown by way of example in FIG. 2) (in the sense of a label) onto containers 2 by way of an ink jet, a transport section 5 for separated transport of hot-end-coated containers 2 to printing machine 3, and a cooling tunnel 6 arranged in the region of transport section 5 for cooling down containers 2, which have been heated to an initial temperature TA as a result of hot end coating, substantially to a printing temperature TD for direct printing, for example, to room temperature.

Transport section 5 is configured for the separated transport of containers 2 at distances 7 from one another or corresponding gaps therebetween, respectively. This prevents that containers 2 collide with one another in the wall regions provided for printed image 4 and can be mechanically damaged during transport.

Transport section 5 receives containers 2 from a hot end coating unit 8 (only indicated schematically) which is arranged in the outfeed region of a glass machine 9 for forming containers 2. Glass machine 9 can operate in a manner known in principle for the production of hollow glass using the blow-blow or press-blow method. It is also indicated schematically that glass machine 9 can be configured as a rotary machine.

Containers 2 are preferably bottles and are made of silicate glass. Its hot end coating is a method that is known in principle and is therefore not explained in detail.

The decisive factor for the invention is that containers 2 are transported in a suitable manner, in particular separated, to printing machine 3 immediately after their hot end coating and, on the way there, are cooled down from their initial temperature TA (defined in the outfeed of hot end coating unit 8 and/or in an infeed region 5a of transport section 5) to printing temperature TD. In principle, it would also be conceivable that an additional temperature correction to printing temperature TD is carried out immediately prior to the first printing step in the region of printing machine 3.

As can be seen from FIG. 2, transport section 5 in the simplest case comprises a conveyor belt 5b on which containers 2 preferably stand upright at a distance 7 from one another. As an alternative or in addition, endlessly circulating transport mechanisms with grippers 5c, corresponding long-stator systems, or similar transport mechanisms are also conceivable. Direction of transport 5d of transport section 5 is furthermore shown.

Bottom-free transport or transport in which containers 2 are only held at a neck region 2a and/or a base/heel region 2b would therefore also be possible in order to free a wall region 2c of containers 2 provided for printed image 4 or to keep it free from contact with grippers 5c, respectively. This is also indicated schematically in FIG. 2.

It is also shown there, not to scale, that containers 2 preferably each comprise at least one rubbing edge (scuffing edge) 2d which can be made of glass, for example, as part of the container body (shown) or can be printed on by direct printing by printing machine 3 (not shown).

FIG. 1 shows, by way of example, that printing machine 3 can comprise several printing units 10 for applying printing colors/inks, intermediate curing units 11 for the printing colors/inks, and a final curing unit 12 for the printing colors/inks.

In the case of inkjet printing using UV-curing printing colors/inks, intermediate curing units 11 are configured as so-called UV pinning units and final curing unit 12 as UV radiators, which is known in principle.

In the case of ink jet printing using solvent-based printing colors/inks, intermediate curing units 11 and final curing unit 12 are preferably configured for heat drying on the basis of radiant heaters.

Printing units 10 can be configured, for example, to print white ink and chromatic colors, such as CMYK, successively in the direction of transport (arrow). Intermediate curing units 11 are then used for the respective partial curing of the printing color/ink applied immediately beforehand and promote their spreading to a suitable degree.

At least a pretreatment unit 13, for example, for flame pretreatment or plasma pretreatment of containers 2 and/or a priming unit 14 for applying a functional primer (base coat) in the sense of a bonding agent or the like can optionally be arranged in the region of transport section 5 (not shown) and/or of printing machine 3 (shown).

Printing machine 3 can furthermore have a printing unit 15 for applying a transparent protective layer (for example a protective lacquer) onto printed image 4.

It is also indicated schematically in FIG. 1 that a drying tunnel 16 can be present downstream of printing machine 3 and in particular immediately adjoining for drying printed image 4 on containers 2 in a suitable manner, in particular as a result of direct printing using solvent-based printing colors/inks. Their complete drying/curing can be promoted or accelerated in this manner. This is particularly advantageous if the drying/final curing of such printing colors/inks with final curing unit 12 (by way of a radiant heater) in the region of printing machine 3 is not possible or only insufficiently possible.

A packing machine 17 can be present downstream of printing machine 3 for combining the previously still separated containers 2 to form packs 18 and/or on pallets 19 and to thus supply them to multiple transport.

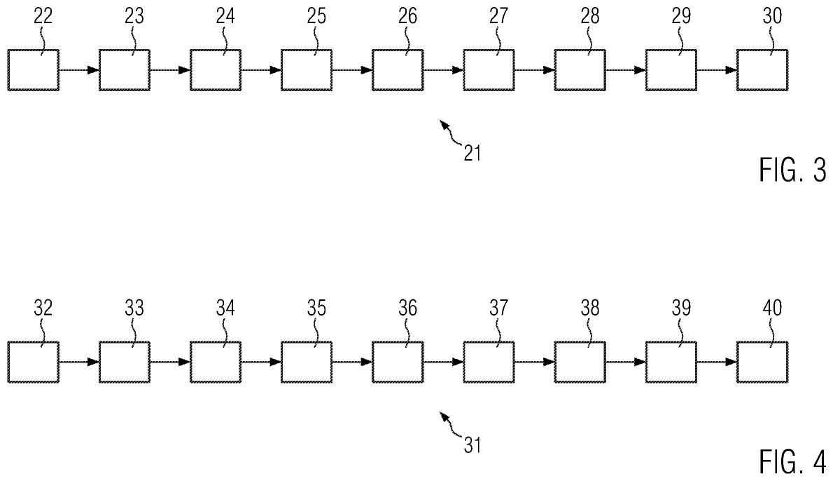

Steps of the method according to the invention are shown schematically in FIG. 3 according to a first embodiment.

According thereto, method 21 according to the first embodiment comprises a first step 22 in which hot-end-coated containers 2 are cooled down from initial temperature TA to printing temperature TD, preferably during the ongoing transport and while maintaining an individual transport at a distance 7 from one another.

The containers can thereafter be pretreated in an optional step 23, for example, by flame pretreatment and/or plasma pretreatment.

Alternatively or additionally, containers 2 can be coated in an optional step 24 with a functional primer in the sense of a bonding agent.

Printed image 4 is then printed directly, first in a step 25, in that the basic color white is printed on and intermediately cured/cured in part by way of UV pinning.

The direct print of printed image 4 is thereafter continued in that the printing colors of a color model, such as CMYK, and optionally so-called spot colors are respectively printed and intermediately cured by way of UV pinning. Chromatic colors applied in this manner can have a mechanical protective function for the later transport and use of containers 2 against scratching, abrasion, or the like.

If the chromatic colors do not have such a protective function or if such a protective function is to be reinforced, then a transparent protective layer (protective lacquer) can be printed on in an optional step 27. The protective layer is then preferably also UV-curing.

In a step 28, the final UV curing of the print layers (printed image 4 and optionally protective layer) takes place thereafter.

As an alternative to step 27, an organic protective layer could be subsequently applied in the sense of a cold end coating in step 29 in order to increase the mechanical resistance of containers 2 and of printed image 4.

FIG. 4 shows a corresponding sequence of method 31 according to a second embodiment based on printing colors/inks that cure by evaporating a solvent such as water.

In this case, steps 32, 33, and 34 correspond to steps 22, 23 and 24 of first embodiment 21, so that no further explanation is presently required.

Steps 35 and 36 also correspond substantially to steps 25 and 26 of first embodiment 21 with regard to the color design of printed image 4. However, the intermediate curing that is obligatory in UV direct printing is replaced by optional heat drying of the respective printing colors/inks by way of infrared radiation (radiant heaters), likewise the final curing of the printing colors/inks.

Alternatively, it would also be conceivable in the case of solvent-based printing colors/inks to set the printing temperature TD to a value that is suitably raised above room temperature so that additional heat drying after the individual printing steps could be dispensed with.

A transparent protective layer (protective lacquer) is applied in step 37.

Printed image 4 and/or the protective layer applied immediately beforehand is finally cured in step 38. This can take place, for example, in a heat tunnel (not shown).

As an alternative to step 37, an organic protective layer could be applied in the sense of a cold end coating in step 39 for increasing the mechanical resistance of containers 2 and of printed image 4.

After all printed layers (printed image 4 and optionally protective layer) have cured, the then sufficiently mechanically protected containers 2 can be transferred from separated transport to multiple transport in a step 30 (first embodiment 21) or 40 (second embodiment 31). This is done, for example, by combining containers 2 to form packs 18 and/or on pallets 19.

Methods 21, 31 described represent a considerable simplification compared to printing methods in which direct printing takes place onto containers after their cold end coating. Accordingly, raw materials can be saved and the number of method steps can be reduced. This leads to savings in production time, material, and energy costs.

1. Method for printing onto containers made of glass in which said containers in a state heated by hot end coating are transferred to a transport section and are transported thereon to a printing machine, and where said containers are cooled down to a printing temperature in the region of said transport section and/or of said printing machine and are then provided with a printed image in said printing machine by direct printing.

2. Method according to claim 1, where said containers are transported separated and at a distance throughout from one another from an infeed region of said transport section to the direct printing.

3. Method according to claim 1, where said containers are guided and/or held on said transport section, while leaving a lateral wall region free that is provided for said printed image.

4. Method according to claim 1, where said containers have at least one rubbing edge formed from glass which keeps lateral wall regions of said containers for receiving said printed image at a distance from one another when said containers contact each other, or a rubbing edge corresponding functionally in this regard is applied by the direct printing.

5. Method according to a claim 1, where said containers are cooled substantially to said print temperature in a cooling tunnel.

6. Method according to claim 1, where the direct printing comprises the application of a primer layer onto a hot end coating layer produced by the hot end coating.

7. Method according to claim 1, where said printed image is produced by way of inkjet printing.

8. Method according to claim 6, where the direct printing comprises the application of a transparent protective layer onto said printed image.

9. Method according to claim 1, where said containers transported separated are combined by machine downstream of the direct printing to form packs and/or by palletizing for multiple transport.

10. Method for producing containers made of glass for bottling beverages, comprising melt-forming said containers, their hot end coating immediately downstream and the immediately downstream execution of the method according to claim 1.

11. Container made of glass comprising: a container body made of silicate glass, a hot end coating layer formed thereon, and a printed image applied thereonto in direct printing directly or by way of an adhesion layer, including according to the method according to claim 1.

12. Device for direct printing onto containers made of glass following their hot end coating, comprising: a printing machine for direct printing onto said containers; at least one transport section for separated transport of said hot-end-coated containers from an outfeed region of a hot end coating unit to said printing machine; and a cooling tunnel arranged in the region of said transport section for cooling down said containers, heated as a result of the hot end coating, to a printing temperature for direct printing.

13. Device according to claim 12, furthermore comprising a pretreatment unit arranged in the region of said transport section and/or said of printing machine for preparing a coating layer produced on said containers with hot end coating by way of plasma treatment and/or flame treatment and/or for spraying on an adhesion layer for the respective subsequent direct printing.

14. Device according to claim 12, where said transport section comprises grippers that are movable in the direction of transport for a neck finish portion and/or base portion of said containers, including while leaving free a wall region of said containers that is intended for said printed image.

15. Device for the production of containers made of glass comprising said device according to claim 12 and upstream thereof a glass machine for melt-forming said containers and a downstream hot end coating unit for producing a hot end coating layer on said containers.
